(19) United States
(12) Patent Application Publication
(10) Pub. No.: US 2026/0228515 A1
(43) Pub. Date: Aug. 6, 2026

(54) NEURAL NETWORK WITH FUSED OPERATORS

(71) Applicant: MONTAGE TECHNOLOGY CO., LTD., Shanghai (CN)

(72) Inventors: Qian WU, Shanghai (CN); Ming LI, Shanghai (CN); Qi XU, Shanghai (CN)

(21) Appl. No.: 19/180,103

(22) Filed: Apr. 15, 2025

(30) Foreign Application Priority Data
May 30, 2024 (CN) 202410694888.7

(51) Int. Cl. G06N 3/0495; G06N 3/0464

(52) U.S. Cl. CPC G06N 3/0495; G06N 3/0464

(57) ABSTRACT

The present application relates to a neural network with fused operators. The neural network comprises a convolution operation having a convolution sub-operation and a bias sub-operation, and an element-wise operation following the convolution operation. The neural network is deployed in an artificial intelligence accelerator having a convolution unit for performing the convolution sub-operation and a single point processing unit for performing the element-wise operation. The single point processing unit comprises a plurality of sub-module circuits that are connected sequentially and configured with respective configuration parameters. The configuration parameters are determined by the following steps: determining operation relationships of fused operations fusing the bias sub-operation and the element-wise operation; determining the configuration parameters of the plurality of sub-module circuits, and configuring the plurality of sub-module circuits and configuring the convolution unit and the single point processing unit.

### TECHNICAL FIELD

This application relates to the field of artificial intelligence technology, and more specifically, to a neural network with fused operators.

### BACKGROUND OF THE INVENTION

In artificial intelligence (AI) scenarios, as the difficulty of application increases and deep learning models become more complicated, the number of intermediate parameters that need to be stored increases gradually, which may need to consume larger memory resources. An AI accelerator (also known as an AI compute card or an AI chip), such as a Graphic Processing Unit (GPU) and a Network Processing unit (NPU), is an application-specific hardware accelerator or a computer system commonly used for accelerating neural network processing. The AI accelerator generally uses an on-chip memory to improve its performance. During computation, data is loaded from an external memory (e.g., a DRAM) to the on-chip memory (e.g., a SRAM), and after the computation is completed, a portion of a computation result exceeding the capacity of the on-chip memory is stored back to the external memory. Therefore, there are frequent data transfers between the on-chip memory and the external memory, which greatly increases the memory access overhead. Moreover, with a large increase in computing resources, an amount of data exchange between the external memory and the on-chip memory increases, which further aggravates the memory access overhead between the memories. In addition, operation units of the AI accelerator also have time overheads when they are started up. All of the above factors have become bottlenecks in the development of AI accelerators.

In view of the above, there is a need for an improved neural network with fused operators.

### SUMMARY OF THE INVENTION

An objective of the present application is to provide a neural network with fused operators to optimize the overall operation performance of a convolution operation and a following element-wise operation.

In an aspect of the present application, a neural network with fused operators, wherein the neural network comprises a convolution operation having a convolution sub-operation and a bias sub-operation, and an element-wise operation following the convolution operation; wherein the neural network is deployed in an artificial intelligence accelerator having a convolution unit for performing the convolution sub-operation and a single point processing unit for performing the element-wise operation; wherein the single point processing unit comprises a plurality of sub-module circuits that are connected sequentially and configured with respective configuration parameters, and wherein the configuration parameters of the plurality of sub-module circuits are determined by the following steps: determining, based on an operation relationship of the convolution operation and an operation relationship of the element-wise operation, operation relationships of fused operations fusing the bias sub-operation of the convolution operation and the element-wise operation; determining, based on the operation relationship of the fused operation, the configuration parameters of the plurality of sub-module circuits, and configuring, based on the configuration parameters, the plurality of sub-module circuits, such that the single point processing unit can perform the fused operation based on the configuration parameters; and configuring the convolution unit and the single point processing unit, such that the convolution unit and the single point processing unit can perform the sub-convolution operation and the fused operation in a pipeline mode.

The foregoing general description is an overview of the present application, which may involve simplification, generalization, and omission of details. Therefore, those skilled in the art should recognize that this section is exemplary and explanatory only, and is not intended to restrict the invention in any way. This general description is neither used to identify key or essential features of the claimed subject nor to serve as an aid in determining the scope of the claimed subject.

### BRIEF DESCRIPTION OF DRAWINGS

Through the combination of the following description, the appended claims and the drawings, the above and other features of the present application will be understood more fully and clearly. It should be understood that the drawings referenced herein illustrate only some several embodiments of the content of this application, and thus should not be regarded as limitation of the scope of the present application. The content of the present application will be illustrated more clearly and in detail through the drawings.

FIG. 1 shows a partial diagram of a ResNet50-int8 engine generated by an AI compiler without fused operators.

FIG. 2 shows a diagram of a Single Data Processor (SDP) unit of an NVDLA (http://nvdla.org/hw/v1/ias/unit_description.html, “FIG. 63 Single Point Data Processing block diagram”).

FIG. 3 shows a principle of operator fusion according to an embodiment of the present application.

FIG. 4 shows a configuration diagram of an SDP unit after a bias sub-operation and an element-wise addition operation is fused according to an embodiment of the present application.

FIG. 5 shows a partial diagram of an AI accelerator before and after a bias sub-operation and an element-wise addition operation is fused according to an embodiment of the present application.

FIG. 6 shows a configuration diagram of an SDP unit after a bias sub-operation and an element-wise multiplication operation is fused according to an embodiment of the present application.

FIG. 7 shows a partial diagram of a ResNet50-int8 engine after operator fusion and optimization according to an embodiment of the present application.

FIG. 8 shows a comparison chart of statistical numbers of operators of ResNet50-int8 before and after operator fusion and optimization according to an embodiment of the present application.

FIGS. 9A and 9B respectively show partial diagrams of a ResNet,50-fp32 engine before and after operator fusion and optimization according to an embodiment of the present application.

FIG. 10 shows a comparison chart of statistical numbers of operators of ResNet50-fp32 before and after operator fusion and optimization according to an embodiment of the present application.

### DETAILED DESCRIPTION OF THE INVENTION

The following detailed description of exemplary embodiments of the application refers to the accompanying drawings that form a part of the description. In the drawings, similar symbols typically represent similar components unless otherwise specified by the context. The illustrative embodiments described in the detailed description, the drawings and the claims are not intended to limit. It should be understood that other embodiments may be employed and other changes may be made without departing from the spirit or scope of the present application. It should be understood that various configurations, substitutions, combinations, and designs of the various aspects of the present application that are generally described and illustrated in the drawings may be made, and all of these are incorporated as part of the present application.

Neural networks are widely used in the processing of video, image, text, sound, and other types of data. The data processing by a neural network generally includes many types of operation, such as a convolution operation, an element-wise operation, a linear operation, a pooling operation, an activation operation, etc. The neural networks, such as neural network models like ResNet, Inception v3, may include branches; while the neural networks, such as neural network models like VGG (Visual Geometry Group), may not include branches.

The convolution operation is a typical operation of a neural network. In general, the convolution operation implemented by a neural network may include a convolution sub-operation and a following bias sub-operation. In the convolution sub-operation, data to be convolved and convolution weights are convolved. A bias item of the bias sub-operation may be a constant value, and act on the data to be convolved together with the convolution weights to adjust an offset of a convolution result. In practical applications, the value of the bias item may be obtained by training, or may be directly designated, for example, may be set to 0 or a constant. After performing the convolution operation, the neural network may perform a further operation on the output convolution result. For example, an element-wise operation is performed on the output convolution result, which is a bit-wise operation on corresponding elements between two tensors of the same shape (size). The element-wise operation is a memory-intensive operation, which has low computation complexity but high memory access overhead. The element-wise operation may include an element-wise addition operation, an element-wise multiplication operation, an element-wise subtraction operation, or an element-wise division operation. For example, in a ResNet model, a residual block may have two branches, in which one branch performs the convolution operation and the other branch delivers unprocessed or processed residuals, and the element-wise addition (ADD) operation is performed on the results of the two branches.

An AI accelerator is a hardware chip, which is specially designed to implement the operations of a neural network smoothly and rapidly. Examples of AI accelerators include a graphics processing unit (GPU), a vision processing unit (VPU), and a tensor processing unit (TPU). Computation tasks of the neural network, such as training and inference, may be abstracted into a computation graph to be performed, which may include a plurality of operators, such as a convolution (CONV) operator, a bias operator, an element-wise operator, a batch normalization (BN) operator, etc. In the computation graph the operators may be connected by directed edges to indicate data dependency relationships among the operators. In a deep learning computation, the execution of a large number of operators requires frequent data exchange between an on-chip memory and an off-chip memory (e.g., an external memory), which results in large memory access overhead and affects computation efficiency.

NVDLA (NVIDIA Deep Learning Accelerator) is a free and open architecture for AI accelerators released by NVIDIA Corporation. NVDLA introduces a modular architecture, which mainly includes a convolution core unit, a single data processor (SDP) unit, a planar data processor (PDP) unit, etc. These units can be configured with respective parameters, and different units may be configured independently. The relevant materials for NVDLA refer to its web page introduction at https://github.com/nvdla/doc/.

The convolution core unit of the NVDLA accelerator may be used to perform the convolution sub-operation, and the SDP unit may be used to, for example, perform the bias sub-operation and the element-wise operation after the convolution sub-operation. In this case, the output of the bias sub-operation is written into the on-chip memory such as a SRAM. The following element-wise operation needs to read a result of the bias sub-operation from the on-chip memory again. It may be understood that, in some cases, the memory space of the on-chip memory may not be able to store the result of the bias sub-operation, and thus the result of the bias sub-operation may be at least partially stored in the off-chip memory. Accordingly, the following element-wise operation also needs to read the at least partial result of the bias sub-operation from the off-chip memory, which may significantly increase the amount of access to the on-chip memory and/or the off-chip memory.

Various units of the AI accelerator are designed to be dedicated to different operations. For example, some operations of the neural network require processing a single data point, such as precision scaling, batch normalization, bias sub-operation, element-wise operation, activation operation, etc. In order to accelerate such operations, some AI accelerators have dedicated single point processing units, such as the SDP unit of NVDLA. In addition, some AI accelerators have dedicated convolution units, such as the convolution core unit of NVDLA.

As mentioned above, many factors need to be considered for the performance of the AI accelerator implementing the neural network, especially the need to balance operation and resource occupancy. In view of the common combination of the convolution operation and the following element-wise operation in the neural network, the present application proposes a neural network with fused operators. The neural network is deployed in an AI accelerator, and can fuse a bias sub-operation of a previous convolution operation with a subsequent element-wise operation, that is, fuse a bias operator and an element-wise operator. The fused bias operator and element-wise operator can be executed by a single point processing unit by configuring configuration parameters of circuits of the single point processing unit correspondingly. Moreover, the scheme makes the convolution unit and the single point processing unit run in pipeline, thereby reducing memory access overhead and startup overhead, increasing utilization of hardware resources, and improving chip performance. In some embodiments, the present application may be applied to any suitable AI accelerators.

It should be noted that, in the following embodiments, the neural network with fused operators of the present application is mainly described by taking some circuit modules implemented in NVDLA as examples, but it can be understood that the neural network with fused operators of the present application is not limited to being applied to the following circuit modules of NVDLA, and can also be applied to other modules with similar functions in NVDLA or other similar AI accelerator. In addition, it can be understood that the neural network with fused operators of the present application is not limited to the type of neural network exemplarily described in the following embodiments, but can also be applied to other types of neural network, such as other convolutional neural networks, deep neural networks, recurrent neural networks, etc. Next, the neural network with fused operators of the present application will be further described with reference to specific embodiments.

### Embodiment 1: Fusion of Bias Sub-Operation and Element-Wise Addition Operation of a Quantized Model

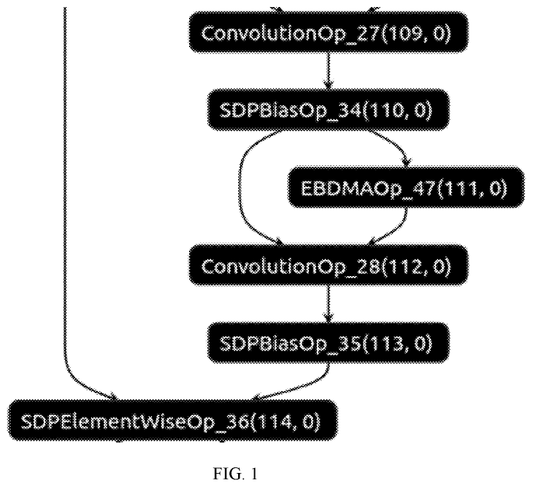

The operator fusion method provided in an embodiment of the present application will be described with reference to FIG. 1. In the present embodiment, a neural network model ResNet50-int8 is deployed in an AI accelerator with an NVDLA accelerator architecture, and the AI accelerator includes a convolution unit for performing a convolution operator and a single point processing unit for performing a fused bias operator and an element-wise operator. In order to determine configuration parameters of circuits of the single point processing unit in the AI accelerator, the fusion between the bias operator and an element-wise addition operator is described as an example, with the following details.

First, as shown in FIG. 1, a engine graph (computation graph) of the neural network without fusion is provided. FIG. 1 shows a partial diagram of ResNet50-int8 engine without fused operator generated by an AI compiler. Each block in the engine graph represents a hardware engine module corresponding to an operator, and the arrows represent respective data flows. Taking three operators at the bottom as an example, they are a convolution operator ConvolutionOp, a bias operator SDPBiasOp, and an element-wise operator SDPElementWiseOp. The convolution operator ConvolutionOp corresponds to a convolution sub-operation in a convolution operation, and is performed by the convolution unit. The bias operator SDPBiasOp corresponds to a bias sub-operation in the convolution operation, and is performed by a SDP unit. The element-wise operator SDPElementWiseOp corresponds to an element-wise operation, and is also performed by the SDP unit. That is, without fused operator, the SDP unit needs to be started up twice.

It can be understood that, because the arrows in the engine graph represent respective data flows, the bias operator and the element-wise operator have a data dependency relationship. It can also be understood that, in the present embodiment, the element-wise operator is an element-wise addition (ADD) operator, and in other embodiments, the element-wise operator may be an element-wise multiplication (MUL) operator, an element-wise subtraction (SUB) operator, etc.

In the present embodiment, the bias operator and the element-wise operator having a data dependency relationship may be quantized to obtain a fused operator of the bias operator and the element-wise operator.

Specifically, fusing the bias operator and the element-wise operator and enabling the SDP unit to execute the fused operator may include: 1) quantizing the convolution operation and the element-wise operation, and determining parameters corresponding to the fused operator which fuses the bias operator and the element-wise operation based on an operation relationship between the quantized convolution operation and the element-wise operation; 2) adaptively adjusting parameters corresponding to the fused operator to configuration parameters which meet the configuration requirements of the SDP unit; and 3) configuring parameters for the SDP unit, so that the SDP unit can perform the fused operator based on the configuration parameters.

In the following, the fusion principle is explained in detail in combination with the structure of the SDP unit and the operation relationship between the quantized convolution operation and the quantized element-wise operation.

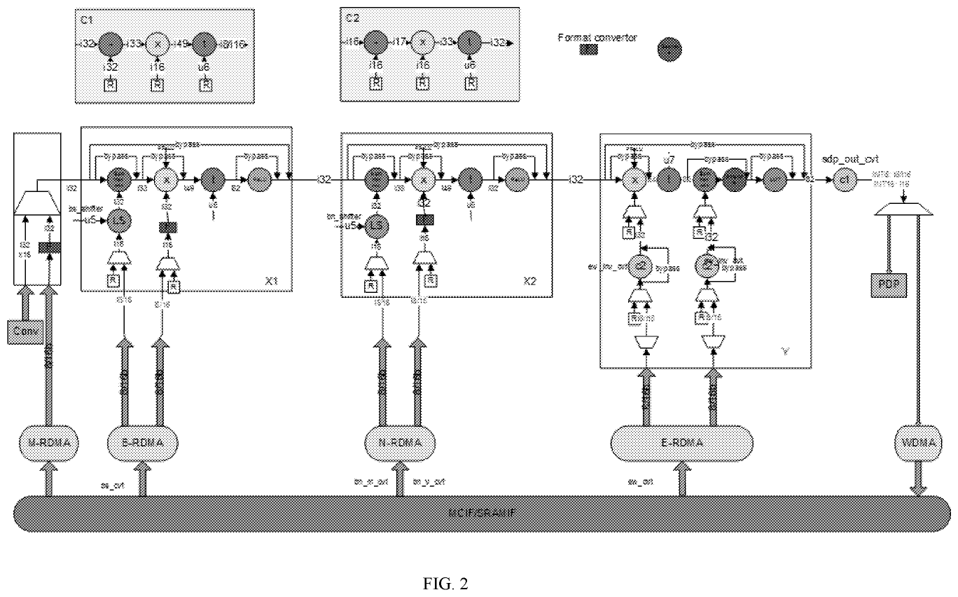

FIG. 2 illustrates an exemplary diagram of the SDP unit of the NVDLA architecture. As shown in FIG. 2, the SDP unit includes a plurality of sub-module circuits, for example, sub-modules X1 and X2 have the same structure and support functions such as bias and addition. A sub-module Y is originally designed to perform the element-wise operation, and also supports functions such as the bias and the addition. Sub-modules C1 and C2 are used for additional scaling and offset to save bits (http://nvdla.org/hw/v1/ias/unit_description.html). Each sub-module circuit has a set of configuration parameters, which can be configured according to weights of the neural network.

An operation relationship of the convolution operation and the element-wise operation without fused operator is as follows.

First, the operation relationship of the convolution operation is quantized by using Equation (1):

$${S}_{o} \times ( Y - {Z}_{o} ) = {S}_{i} \times {S}_{w} \times [ ( X - {Z}_{i} ) * ( W - {Z}_{w} ) + B ] \qquad ( 1 )$$

where Sₒ is an output scale factor of the convolution operation, Y is an output of the convolution operation, Zₒ is an output zero point of the convolution operation, Sᵢ is an input scale factor of the convolution operation, S_{w} is a weight scale factor of the convolution operation, X is an input of the convolution operation, Zᵢ is an input zero point of the convolution operation, W is a weight of the convolution operation, Z_{w} is a weight zero point of the convolution operation, B is a bias value, * indicates convolution operation, x indicates multiplication.

That is, an output of the convolution operation can be expressed by Equation (2) as follows:

$$Y = ( {S}_{i} \times \frac{{S}_{w}}{{S}_{o}} ) \times [ X * ( W - {Z}_{w} ) + ( - {Z}_{i} * ( W - {Z}_{w} ) ) + B + \frac{{z}_{o}}{{S}_{i} \times \frac{{S}_{w}}{{S}_{o}}} ] \qquad ( 2 )$$

Equation (2) can be further modified to be expressed by Equation (3) as follows, in which it should be noted that, since the convolution operation includes the convolution sub-operation and the following bias sub-operation, the output Y of Equation (2) is also an output of a quantized bias sub-operation.

$$Y = ( {S}_{i} \times \frac{{S}_{w}}{{S}_{o}} ) \times [ X * {W}^{′} + {B}^{′} ] \qquad ( 3 )$$

$$where$$

$${W}^{′} = ( W - {Z}_{w} ) , {B}^{′} = ( - {Z}_{i} * ( W - {Z}_{w} ) ) + B + \frac{{z}_{o}}{{S}_{i} \times \frac{{S}_{w}}{{S}_{o}}} .$$

In addition, an operation relationship of the ADD operation can be quantized by using Equation (4):

$${S}_{o} \times ( Y - {Z}_{o} ) = {S}_{i 1} \times ( {X}_{1} - {Z}_{i 1} ) + {S}_{i 2} \times ( {X}_{2} - {Z}_{i 2} ) \qquad ( 4 )$$

where Sₒ is an output scale factor of the element-wise addition operation, Y is an output of the element-wise addition operation, Zₒ is an output zero point of the element-wise addition operation, X₁ is a first input (input1) of the element-wise addition operation, Zᵢ₁ is a zero point for the input1 of the element-wise addition operation, Sᵢ₁ is a scale factor of input1 of the element-wise addition operation, X₂ is the second input (input 2) of the element-wise addition operation, Zᵢ₂ a zero point for input2 of the element-wise addition operation, Sᵢ₂ is a scale factor of input2 of the element-wise addition operation, and x indicates multiplication. It is understood that, when there is data dependency relationship between the bias operator and the element-wise addition operator, one of the inputs of the element-wise addition operator (e.g., X₁) is the output of the bias operator.

The output of the ADD operation, Y, can be expressed by Equation (5) or (6) as follows:

$$Y = \frac{{S}_{i 2}}{{S}_{o}} \times ( \frac{{S}_{i 1}}{{S}_{i 2}} \times {X}_{1} + {X}_{2} ) + ( - \frac{{S}_{i 1}}{{S}_{0}} \times {Z}_{i 1} - \frac{{S}_{i 2}}{{S}_{o}} \times {Z}_{i 2} ) + {Z}_{o} \qquad ( 5 )$$

$$Y = \frac{\begin{matrix}[ \frac{{q}_{2} \times ( {q}_{3} \times {X}_{1} + {X}_{2} \times {2}^{shift 3} )}{{2}^{shift 3}} + \\ ( - {q}_{1} \times {Z}_{i 1} - {q}_{2} \times {Z}_{i 2} ) + {Z}_{o} \times {2}^{shift 4} ]\end{matrix}}{{2}^{shift 4}} \qquad ( 6 )$$

$$where {q}_{1} = \frac{{S}_{i 1}}{{S}_{0}} \times {2}^{shift 1} , {q}_{2} = \frac{{S}_{i 2}}{{S}_{o}} \times {2}^{shift 2} , {q}_{3} = \frac{{S}_{i 1}}{{S}_{i 2}} \times {2}^{shift 3} ,$$

$$shift 4 = max ( shift 1 , shift 2 ) .$$

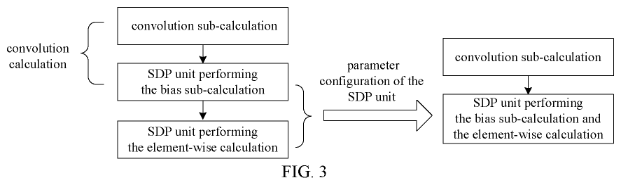

Considering that the bias sub-operation in the above convolution operation can be performed by the SDP unit, and the element-wise addition operation following the convolution operation can also be performed by the SDP unit, the present application proposes a method of fusing the two operations implemented by the SDP unit. Referring to FIG. 3, a principle of operator fusion according to an embodiment of the present application is shown. By configuring parameters of the SDP unit, the method can fuse the element-wise operation and the bias sub-operation in the convolution operation into a fused operation, and the fused operation can be performed in one operation of the SDP unit to reduce occupation of the SDP unit, and reduce an amount of access to the on-chip memory and/or the off-chip memory. Still taking the ADD operation as an example, parameters of the SDP unit can be derived and configured as follows.

According to the above Equation (4), it is obtained that:

$${S}_{o} \times ( Y - {Z}_{o} ) = {S}_{i 1} \times {X}_{1} + {S}_{i 2} \times {X}_{2} + ( - {S}_{i 1} \times {Z}_{i 1} - {S}_{i 2} \times {Z}_{i 2} ) \qquad ( 7 )$$

As described above, X₁ and X₂ are two inputs of the element-wise addition operation, in which one input is the output of the bias sub-operation. X₁ as the output of a bias sub-operation is taken as an example. In this case, the output X₁ in Equation (7) may be replaced by the output Y in Equation (3). In the replacement, it can be set that X_{c}=X*W′ in Equation (3), where X_{c} represents the input of the bias sub-operation in the convolution operation when the bias sub-operation is performed by the SDP unit. At the same time, it should be noted that Sₒ in Equation (3) is the same as Sᵢ₁ in Equation (7), both of which represent the scale factor of the input X₁ or the scale factor of the output of the convolution operation (i.e., the output of the bias sub-operation). After replacement, the following is obtained.

$${S}_{o} \times ( Y - {Z}_{o} ) = {S}_{i 1} \times ( {S}_{i} \times \frac{{S}_{w}}{{S}_{i 1}} ) \times ( {X}_{c} + {B}^{′} ) + {S}_{i 2} \times {X}_{2} + ( - {S}_{i 1} \times {Z}_{i 1} - {S}_{i 2} \times {Z}_{i 2} ) \qquad ( 8 )$$

Equation (8) can be converted to Equation (9) below.

$${S}_{o} \times ( Y - {Z}_{o} ) = {S}_{i} \times {S}_{w} \times ( {X}_{c} + {B}^{′} ) + {S}_{i 2} \times {X}_{2} + ( - {S}_{i 1} \times {Z}_{i 1} - {S}_{i 2} \times {Z}_{i 2} ) \qquad ( 9 )$$

Further, Equation (9) can be converted to Equation (10) below.

$$Y = \frac{{S}_{i 2}}{{S}_{o}} \times ( \frac{{S}_{i} \times {S}_{w}}{{S}_{i 2}} \times ( {X}_{c} + {B}^{′} ) + {X}_{2} ) + ( - \frac{{S}_{i 1}}{{S}_{0}} \times {Z}_{i 1} - \frac{{S}_{i 2}}{{S}_{o}} \times {Z}_{i 2} ) + {Z}_{o} \qquad ( 10 )$$

For fusion operation methods of the present application, the precision of the neural network that performs the method may be different from the precision supported by the SDP unit. For example, the scale factor is of type FP32, but the SDP unit only supports type INT16 at the precision of type INT8, and it is desired to shift and convert the scale factor into a 16-bit format to accommodate type INT16, so that Equation (10) may be converted into Equation (11) in this case. At this time, the operation relationship between the output Y of the ADD operation, X_{c}, and the other input X₂ of the element-wise operation is as follows. It can be seen that the operation relationship relates to at least one of the following: weight parameters of the neural network, quantization configurations of the convolution operation and the element-wise operation, and shift of scale.

$$Y = \frac{\begin{matrix}[ \frac{{q}_{2} \times ( {q}_{3} \times ( {X}_{c} + {B}^{′} ) + {X}_{2} \times {2}^{shift 3} )}{{2}^{shift 3}} + \\ ( - {q}_{1} \times {Z}_{i 1} - {q}_{2} \times {Z}_{i 2} ) + {Z}_{o} \times {2}^{shift 4} ]\end{matrix}}{{2}^{shift 4}} \qquad ( 11 )$$

$${q}_{1} = \frac{{S}_{i 1}}{{S}_{o}} \times {2}^{shift 1} , {q}_{2} = \frac{{S}_{i 2}}{{S}_{o}} \times {2}^{shift 2} , {q}_{3} = \frac{{S}_{i} \times {S}_{w}}{{S}_{i 2}} \times {2}^{shift 3} ,$$

$$shift 4 = max ( shift 1 , shift 2 ) .$$

Correspondingly, the configuration of the SDP unit that fuses the bias sub-operation of the convolution operation and the ADD operation is shown in Table 1, which may be configured in the plurality of sub-module circuits of the SDP unit at one time. After the plurality of sub-module circuits of the SDP unit are configured according to Table 1, the SDP unit may perform the fused operator that fuses the bias sub-operation and the element-wise addition operation.

TABLE 1

| SDP Unit Circuit Parameters | Configuration Values |
|---|---|
| X1-SUM | B′ |
| X1-MUL | q₃ |
| X2-SUM | X₂ |
| X2-LS && X2-TRUNC | shift3 |
| X2-MUL | q₂ |
| OUT-CVT-OFFSET | (−q₁ × Zᵢ₁ − q₂ × Zᵢ₂) + Zₒ × 2^{shift4} |
| OUT-CVT-TRUNC | shift4 |

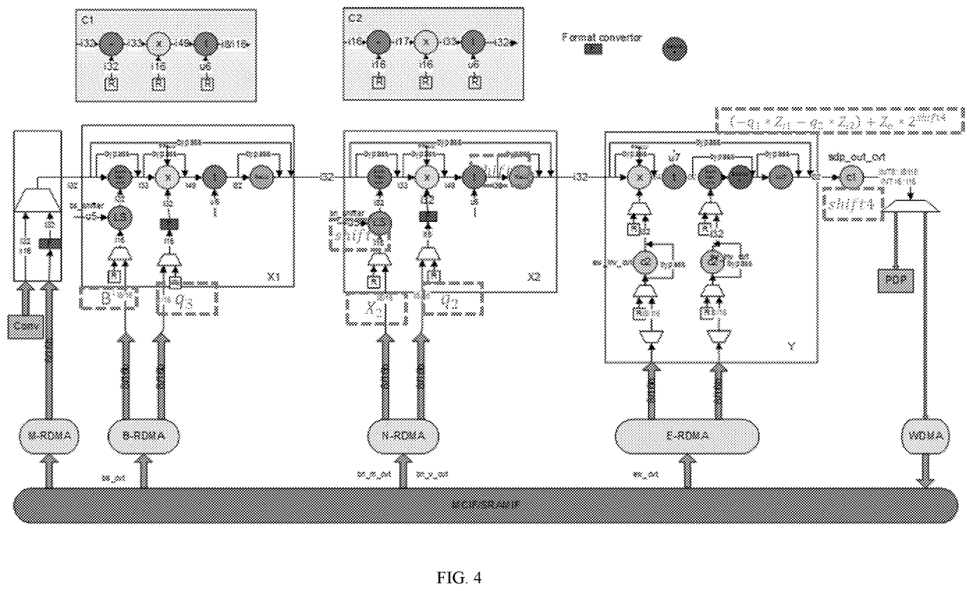

Referring to FIG. 4, a configuration diagram of the SDP unit after fusion according to an embodiment of the present application is shown. FIG. 4 exemplarily illustrates the configuration parameters on the sub-modules of the SDP unit. Optionally, the configuration parameters of the SDP unit may be stored in the on-chip memory of the AI accelerator, or a register may be provided in the SDP unit to store the configuration parameters. In one embodiment, the configuration parameters may also be stored in the off-chip memory.

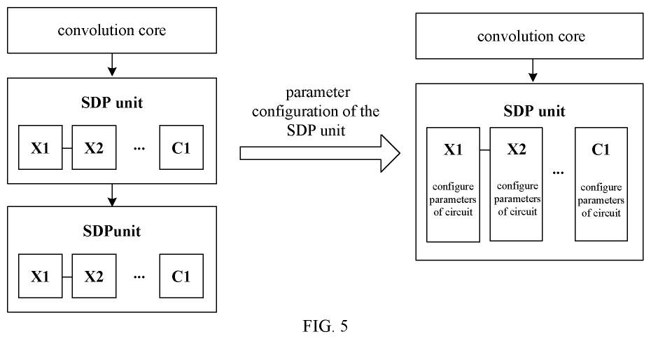

FIG. 5 shows a partial diagram of the AI accelerator according to an embodiment of the present application. Specifically, respective configuration diagrams of the SDP unit before and after the bias sub-operation and the element-wise addition operation are fused are shown. The SDP unit includes a plurality of sub-module circuits that are connected sequentially, such as module X1, module X2, and module C1 of the NVDLA architecture. As shown in the diagram on the left side of FIG. 5, before fusion, the convolution kernel unit of the AI accelerator of the NVDLA architecture executes the convolution sub-operation, and then the SDP unit needs to be executed twice under the default configuration, i.e., first executing the bias sub-operation once, and then executing the element-wise addition operation once. After fusion, as shown in the diagram on the right side of FIG. 5, the convolution kernel unit executes the convolution sub-operation, and then, the configuration parameters of the plurality of sub-module circuits of the SDP unit are determined according to the above Equation (11), and the plurality of sub-module circuits are respectively configured by the configuration parameters, so that the SDP unit executes the fused bias sub-operation and element-wise operation, i.e., only once operation is needed to be executed.

In addition, the convolution unit and the SDP unit can be configured in the scheme, such that the convolution operation and the fused operator fusing the bias sub-operation and the element-wise operation can be performed in a pipeline mode.

It can be understood that the fused operation reduces data transmission between the convolution operation and the element-wise operation, and it is also not needed to start the SDP unit twice for the bias sub-operation and the element-wise operation of the convolution operation, thereby the optimization of time and hardware resources is realized.

It can be understood that the expression of the operation relationship of a fused operation fusing the bias sub-operation and the element-wise operation is not limited to the above embodiment, and it is mainly embodied in that the output of the bias sub-operation is taken as the input of the element-wise operation to determine the expression of the output of the element-wise operation.

Since the processing of image data generally requires a large number of local convolutions, the neural network with fused operators of the present application achieves an improvement in operation speed, especially for the processing of classification, rendering, etc. of image data or similar tensor data. In particular, the fusion of multiple operators realizes the improvement and optimization to the inherent structure of the neural network, and can be implemented in hardware to enhance hardware utilization efficiency, reduce the amount of access, etc., which is not simple mathematical or logical abstraction.

### Embodiment 2: Fusion of Bias Sub-Operation and Element-Wise Multiplication Operation of a Quantized Model

As described above, the element-wise operation can also be an element-wise multiplication (MUL) operation, which can also be performed by a SDP unit. Similar to the Embodiment 1, since a bias sub-operation in a convolution operation is performed by the SDP unit, and the MUL operation is also performed by the SDP unit, the two operations can be fused similarly. In Embodiment 2, before fusion, the convolution operation is quantized as the same as that in the Embodiment 1, referring to Equations (1) to (3), which will not be repeated herein. In this embodiment, output of the convolution operation, that is, output of the bias sub-operation, is the input of the following MUL operation.

Specifically, the MUL operation, operates its operation input X₁ and the other operation input X₂, and the quantization of an operation relationship of the MUL operation, is expressed as Equation (12):

$${S}_{o} \times ( Y - {Z}_{o} ) = {S}_{i 1} \times ( {X}_{1} - {Z}_{i 1} ) \times {S}_{i 2} \times ( {X}_{2} - {Z}_{i 2} ) \qquad ( 12 )$$

where Sₒ is an output scale factor of the element-wise multiplication operation, Y is an output of the element-wise multiplication operation, Zₒ is an output zero point of the element-wise multiplication operation, X₁ is a first input (input1) of the element-wise multiplication operation, Zᵢ₁ is a zero point for input1 of the element-wise multiplication operation, Sᵢ₁ is a scale factor of input1 of the element-wise multiplication operation, X₂ is a second input (input2) of the element-wise multiplication operation, Zᵢ₂ is a zero point for input2 of the element-wise multiplication operation, Sᵢ₂ is a scale factor of input2 of the element-wise multiplication operation, x indicates multiplication.

Equation (12) is transformed in conjunction with the quantized Equation (3) of the convolution operation. Specifically, the output Y of the convolution operation of Equation (3) may be used as the operation input X₁ of the MUL operation in Equation (12). Similarly to the transformation in Embodiment 1, it can be set that X_{c}=X*W′ in Equation (3), where X_{c} represents the input of the bias sub-operation in the convolution operation when the bias sub-operation is performed by the SDP unit. Sₒ in Equation (3) is the same as Sᵢ₁ in Equation (12), both of which represents a scale factor of the input X₁ of the element-wise MUL operation or a scale factor of the output of the convolution operation (i.e., the output of the bias sub-operation). After transformation, the following Equation (13) is obtained.

$${S}_{o} \times ( Y - {Z}_{o} ) = {S}_{i 1} \times ( ( {S}_{i} \times \frac{{S}_{w}}{{S}_{i 1}} ) \times ( {X}_{c} + {B}^{′} ) - {Z}_{i 1} ) \times {S}_{i 2} \times ( {X}_{2} - {Z}_{i 2} ) \qquad ( 13 )$$

that is,

$$Y = \frac{{S}_{i 1} \times {S}_{i 2}}{{S}_{o}} \times ( ( \frac{{S}_{i} \times {S}_{w}}{{S}_{i 1}} ) \times ( {X}_{c} + {B}^{′} ) - {Z}_{i 1} ) \times ( {X}_{2} - {Z}_{i 2} ) + {Z}_{o} \qquad ( 14 )$$

It can be seen that an operation relationship between the output Y of SDP unit after fusion, X_{c}, and the other input X₂ of the element-wise multiplication operation is obtained in Equation (14).

In addition, as described above, a plurality of variables in the operation relationship may be adjusted to correspond to a plurality of configuration parameters of a plurality of sub-modules of the SDP unit, such that the SDP unit is capable of performing a fused operator that fuses a bias sub-operation and the MUL operation based on the corresponding plurality of configuration parameters. As shown in Equation (15) below, it can be seen that in the configuration of the fused method of the present application, the above operation relationship relates to at least one of the following: weight parameters of the neural network, quantization configurations of the convolution operation and the element-wise multiplication operation, and shift of scale, and the other operation input X₂ of the element-wise multiplication operation.

$$Y = \frac{{q}_{1} \times ( \frac{{q}_{2}}{{2}^{shift 1}} \times ( {X}_{c} + {B}^{′} ) - {Z}_{i 1} ) \times ( {X}_{2} - {Z}_{i 2} )}{{2}^{shift 2}} + {Z}_{o} \qquad ( 15 )$$

$$where {q}_{1} = \frac{{S}_{i 1} \times {S}_{i 2}}{{S}_{o}} \times {2}^{shift 1} , {q}_{2} = \frac{{S}_{i} \times {S}_{w}}{{S}_{i 1}} \times {2}^{shift 2} .$$

Correspondingly, the configuration of the SDP unit that fuses the bias sub-operation and the MUL operation is shown in Table 2, which may be configured in the plurality of sub-module circuits of the SDP unit at one time. After the plurality of sub-module circuits of the SDP unit are configured according to Table 2, the SDP unit may perform the fused operator that fuses the bias sub-operation and the element-wise multiplication operation.

TABLE 2

| SDP Unit Circuit Parameters | Configuration Values |
|---|---|
| X1-SUM | B′ |
| X1-MUL | q₂ |
| X1-TRUNC | shift1 |
| X2-SUM | −Zᵢ₁ |
| X2-MUL | q₁ |
| Y-MUL-CVT | Zᵢ₂ |
| Y-MUL | X₂ |
| Y-TRUNC | shift2 |
| OUT-CVT | Zₒ |

In addition, the convolution unit and the SDP unit can be configured in the scheme, such that the convolution operation and the fused operator fusing a bias sub-operation and element-wise operation can be performed in a pipeline mode.

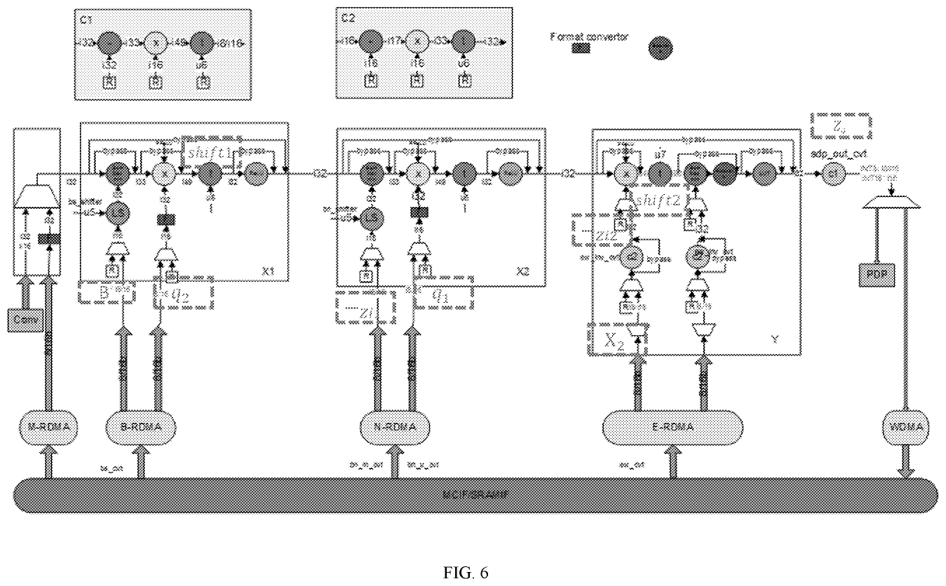

Referring to FIG. 6, a configuration diagram of the SDP unit after fusing the bias sub-operation and the MUL operation according to an embodiment of the present application is shown. FIG. 6 exemplarily illustrates the configuration parameters on the sub-modules of the SDP unit. Optionally, the configuration parameters of the SDP unit may be stored in the on-chip memory of the AI accelerator, or a register may be provided in the SDP unit to store the configuration parameters. In one embodiment, the configuration parameters may also be stored in the off-chip memory.

Referring to FIG. 7, a partial diagram of the ResNet50-int8 Engine after optimization using the present method is shown. In contrast to the ResNet50-int8 Engine without optimization shown in FIG. 1, a SDPBiasOp and a SDPElementWiseOp at the bottom of the Engine graph without optimization (FIG. 1) have been fused into a single SDPElementWiseOp at the bottom of the Engine graph after optimization (FIG. 7). After verification by Veloce, the ResNet50-int8 reduces 150,000 instruction cycles and improves the efficiency by 10.3% after optimization.

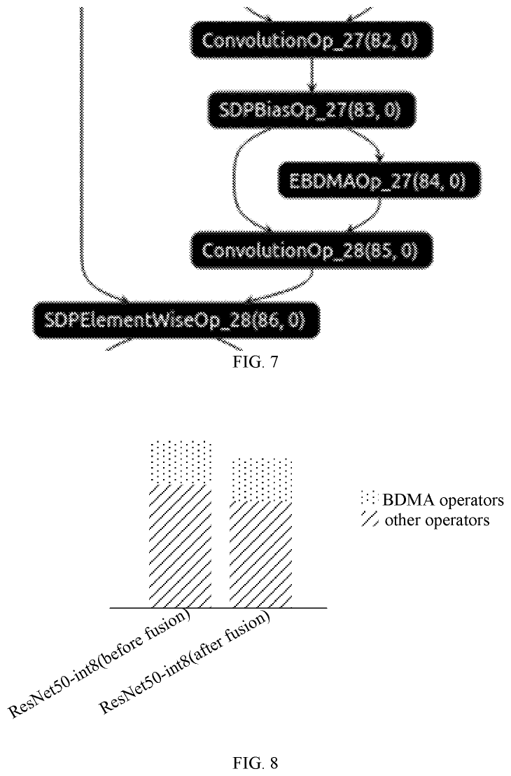

Referring to FIG. 8, a comparison chart of statistical numbers of operators of the ResNet50-int8 before and after optimization using the present method is shown. The left bar of FIG. 8 indicates the number of operators before the ResNet50-int8 fusion, and the right bar indicates the number of operators after the ResNet50-int8 fusion. It can be seen that the number of operators of the ResNet50-int8 after the fusion is reduced by 8% (16). Since the ResNet50-int8 model with or without the fusion can be accommodated by the on-chip memory in the embodiment, the number of BDMA (Bridge DMA) operators is not reduced. It can be understood that when the storage space of the on-chip memory is small, for example, since the element-wise operation may directly overwrite the input data with the output data of the operation, the space occupied by the operation after the fusion may be smaller than the storage space of the on-chip memory, and the operation after the fusion may require less data transfer from the on-chip memory to the off-chip memory than before the fusion, and thus the number of BDMA operators of the model after the fusion may be reduced ideally.

In addition, it can be understood that, after the bias sub-operation and the following element-wise operation are fused, the result of the previous convolution operation does not need to be stored in the on-chip or the off-chip memory first, and then invoked by the following element-wise operation, so that the operation time is shortened and the operation cost is reduced. In addition, after the fusion, the bias sub-operation and the following element-wise operation can be completed by starting the SDP unit only once, which reduces the starting cost of the SDP and improves the utilization rate of the resources.

### Embodiment 3: Fusion of Bias Sub-Operation-Addition/Multiplication Operation of a Floating-Point Model

Similar to Embodiment 1 and Embodiment 2, a bias sub-operation of a convolution operation and an element-wise operation following the convolution operation of a floating-point model can also be fused, but Embodiment 3 differs from the two embodiments in that, unlike the quantized model, the floating-point model is not quantized and does not have parameters such as a scale factor, a zero point, etc. In this embodiment, for the fusion of the bias sub-operation and an ADD operation, the parameter configuration after fusion can refer to Equations (7) to (11) and Table 1, and only the scale factor and the zero point need to be deleted from the equations, while other expressions remain unchanged, which will not be repeated herein. Similarly, for the fusion of the bias sub-operation and an MUL operation, the parameter configuration after fusion can refer to Equations (12) to (15) and Table 2, and only the scale factor and the zero point need to be deleted from the equations, while other expressions remain unchanged, which will not be repeated herein.

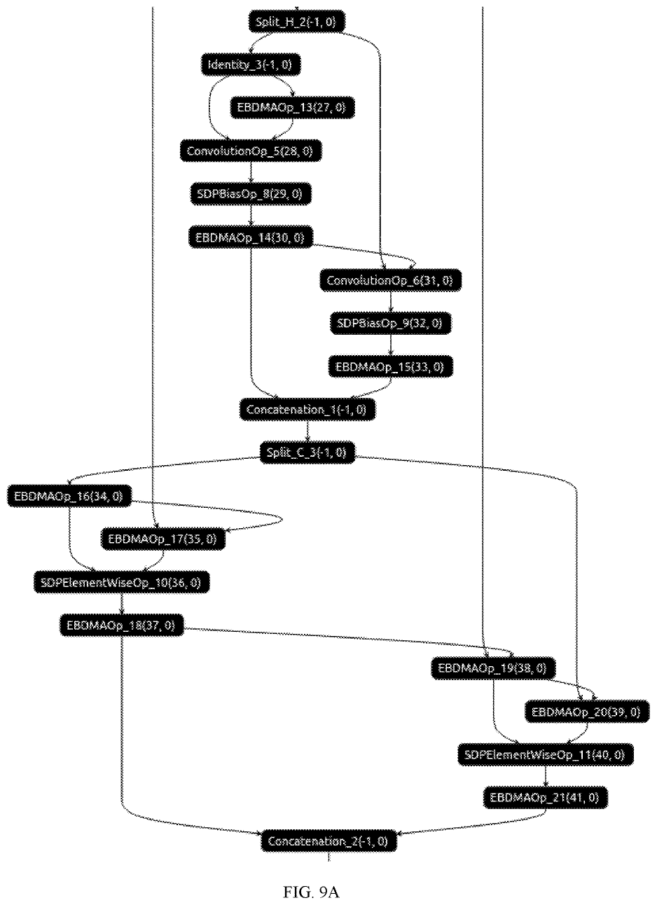

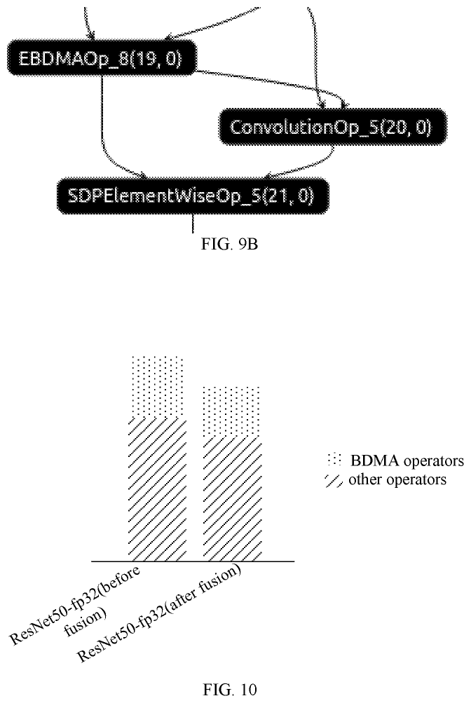

Referring to FIGS. 9A and 9B, respective partial engine graphs of a neural network ResNet50-fp32 before and after operator fusion and optimization according to an embodiment of the present application are shown respectively. It can be seen that, because ResNet50-fp32 is a floating-point model and occupies a large memory space, the model before the optimization needs to enable BDMA for many times to transfer data between the on-chip memory and the off-chip memory, and multiple operation units need to be started and interacted for many times. In contrast, data transfer of the optimized BDMA is reduced and the operation units are reduced.

Referring to FIG. 10, a comparison chart of statistical numbers of operators of a neural network ResNet50-fp32 with fused operators before and after operator fusion and optimization according to an embodiment of the present application is shown. The left bar of FIG. 10 indicates the number of operators of the ResNet50-fp32 before fusion, and the right bar indicates the number of operators of the ResNet50-fp32 after fusion. The number of operators of the ResNet50-fp32 is reduced by 18% (82) after fusion, in which the BDMA operators for data transfer between the off-chip memory and the on-chip memory are reduced by 38 in total. The floating-point model ResNet50-fp32 is relatively large, and the on-chip memory cannot completely accommodate the data in the operation process, and the operation fusion method proposed in the present application can ideally reduce the BDMA operators and reduce the data transfer between the on-chip memory and the off-chip memory. For some AI accelerators, the data transfer delay is the main bottleneck of the running speed of the neural network, and the present method can advantageously solve the memory access problem of the AI accelerator.

It is understood that the present method is not limited to the ADD operation and the MUL operation of the element-wise operation described above. Other element-wise operations can also be fused with the bias sub-operation in the convolution operation by the present method. In addition, as described above, when there is no bias sub-operation in the convolution operation, the convolution operation can be regarded as a bias sub-operation with a bias of zero and fused with the following element-wise operation.

Based on the above embodiments, it can be seen that, by fusing the bias operator and the element-wise operator and performing the convolution operator and the fused operator in a pipeline mode, the present application can fully utilize the hardware resources, reduce the data transfer between the on-chip memories and the off-chip memories, reduce the memory access overhead, reduce the running cost, save the storage space, and reduce the startup overhead, so as to improve the overall performance of the neural network.

Another aspect of the present application provides a computer-readable storage medium, in which instructions are stored. When the instructions are executed by the processor, the processor is configured to execute any of the neural networks with fused operator above. The computer-readable medium referred to in this application include various types of computer storage medium, which can be any available medium that can be accessed by a general-purpose or special-purpose computer. For example, computer-readable medium may include RAM, ROM, EPROM, E2PROM, registers, hard disks, removable disks, CD-ROM or other optical disk memory, disk memory or other magnetic storage devices, or any other temporary or non-temporary medium which can be used to carry or store desired program code units in the form of instructions or data structures, and which can be accessed by a general-purpose or special-purpose computer, or a general-purpose or special-purpose processor. For example, the disk used in this application usually copies data magnetically, while the disk uses laser to copy data optically. The above combination should also be included in the protection scope of computer-readable medium. The exemplary storage medium is coupled to the processor such that the processor can read and write information from/to the storage medium. Alternatively, the storage medium can be integrated into the processor. The processor and storage medium can reside in the ASIC.

It should be noted that although several parts or modules of the neural network with fused operator are mentioned in the above detailed description, such division is exemplary and not mandatory. Practically, according to the embodiments of the present application, the features and functions of two or more modules described above can be embodied in one module. In contrast, the features and functions of a module described above can be further divided into multiple modules to be embodied.

Those of ordinary skill in the art can understand and implement other changes to the disclosed embodiments by studying the description, the content of the disclosure, the drawings and the appended claims. In the claims, the word “comprise” does not exclude other elements and steps, and the word “a” and “an” do not exclude plurals. In the actual application of this application, one part may perform the functions of multiple technical features cited in the claims. Any reference signs in the claims should not be construed as limiting the scope.

1. A neural network with fused operators, wherein the neural network comprises a convolution operation having a convolution sub-operation and a bias sub-operation, and an element-wise operation following the convolution operation; wherein the neural network is deployed in an artificial intelligence accelerator having a convolution unit for performing the convolution sub-operation and a single point processing unit for performing the element-wise operation; wherein the single point processing unit comprises a plurality of sub-module circuits that are connected sequentially and configured with respective configuration parameters, and wherein the configuration parameters of the plurality of sub-module circuits are determined by the following steps:
determining, based on an operation relationship of the convolution operation and an operation relationship of the element-wise operation, operation relationships of fused operations fusing the bias sub-operation of the convolution operation and the element-wise operation;
determining, based on the operation relationship of the fused operation, the configuration parameters of the plurality of sub-module circuits, and configuring, based on the configuration parameters, the plurality of sub-module circuits, such that the single point processing unit can perform the fused operation based on the configuration parameters; and
configuring the convolution unit and the single point processing unit, such that the convolution unit and the single point processing unit can perform the sub-convolution operation and the fused operation in a pipeline mode.

2. The neural network according to claim 1, wherein the configuration parameters of the plurality of sub-module circuits are stored in an on-chip memory of the artificial intelligence accelerator.

3. The neural network according to claim 1, wherein a precision of the neural network is different from a precision supported by the single point processing unit.

4. The neural network according to claim 1, wherein the element-wise operation is an element-wise addition operation or an element-wise multiplication operation.

5. The neural network according to claim 1, wherein the artificial intelligence accelerator has an NVDLA accelerator architecture, and the single point processing unit is a single data processor unit of the NVDLA accelerator architecture.

6. The neural network according to claim 1, wherein determining operation relationships of fused operations fusing the bias sub-operation of the convolution operation and the element-wise operation comprises: determining an operation relationship between an output of the element-wise operation with at least one of the following: weight parameters of the neural network, a quantization configuration of the convolution operation, a quantization configuration of the element-wise operation, and a shift of scale.

7. The neural network according to claim 1, wherein the neural network is a neural network for inference.

8. The neural network according to claim 1, wherein the neural network is a quantized neural network or a floating point neural network.

9. The neural network according to claim 1, wherein the neural network is a quantized neural network for inference, the element-wise operation is an element-wise addition operation comprising adding a first operation input and a second operation input, wherein the first operation input is an output of the bias sub-operation, the artificial intelligence accelerator has an NVDLA accelerator architecture and the single point processing unit is a single data processor unit of the NVDLA accelerator architecture, the configuration parameters of the sub-module circuits comprise X1-SUM, X1-MUL, X2-SUM, X2-LS && X2-TRUNC, X2-MUL, OUT-CVT-OFFSET and OUT-CVT-TRUNC, and wherein configuring the sub-module circuits comprises:
configuring the plurality of parameters X1-SUM, X1-MUL, X2-SUM, X2-LS && X2-TRUNC, X2-MUL, OUT-CVT-OFFSET and OUT-CVT-TRUNC of the sub-module circuits as B′, q₃, X₂, shift3, q₂, (−q₁×Zᵢ₁−q₂×Zᵢ₂)+Zₒ×2^{shift4} and shift4, wherein
$${B}^{′} = ( - {Z}_{i} * ( W - {Z}_{w} ) ) + B + \frac{{Z}_{o}}{{S}_{i} \times \frac{{S}_{w}}{{S}_{o}}} ,$$
where Sₒ is an output scale factor of the convolution operation, Zᵢ is an input zero point of the convolution operation, Zₒ is an output zero point of the convolution operation, Sᵢ is an input scale factor of the convolution operation, S_{w} is a weight scale factor of the convolution operation, W is a weight of the convolution operation, Z_{w} is a weight zero point of the convolution operation, B is a bias value of the convolution operation, * indicates convolution, and x indicates multiplication; wherein
$${q}_{1} = \frac{{S}_{i 1}}{{S}_{o}} \times {2}^{shift 1} , {q}_{2} = \frac{{S}_{i 2}}{{S}_{o}} \times {2}^{shift 2} , {q}_{3} = \frac{{S}_{i} \times {S}_{w}}{{S}_{i 2}} \times {2}^{shift 3} ,$$
$$shift 4 = max ( shift 1 , shift 2 ) .$$
where X₂ is a second input of the element-wise addition operation, Sᵢ₁ is a scale factor of a first input of the element-wise addition operation, Sᵢ₂ is a scale factor of the second input of the element-wise addition operation, Zᵢ₁ is a zero point for the first input of the element-wise addition operation, Zᵢ₂ is a zero point for the second input of the element-wise addition operation, Sₒ is an output scale factor of the element-wise addition operation, Zₒ is an output zero point of the element-wise addition operation, Sᵢ is the input scale factor of the convolution operation, and S_{w} is the weight scale factor of the convolution operation, and x indicates multiplication.

10. The neural network according to claim 1, wherein the neural network is a quantized neural network for inference, the element-wise operation is an element-wise multiplication operation comprising multiplying a first operation input and a second operation input, wherein the first operation input is an output of the bias sub-operation, the artificial intelligence accelerator has an NVDLA accelerator architecture, and the single point processing unit is a single data processor unit, the configuration parameters of the sub-module circuits comprise X1-SUM, X1-MUL, X1-TRUNC, X2-SUM, X2-MUL, Y-MUL-CVT, Y-MUL, Y-TRUNC and OUT-CVT, and wherein configuring the sub-module circuits comprises:
configuring the plurality of parameters X1-SUM, X1-MUL, X1-TRUNC, X2-SUM, X2-MUL, Y-MUL-CVT, Y-MUL, Y-TRUNC and OUT-CVT of the sub-module circuits as B′, q₂, shift1, −Zᵢ₁, q₁, Zᵢ₂, X₂, shift2, Zₒ, wherein
$${B}^{′} = ( - {Z}_{i} * ( W - {Z}_{w} ) ) + B + \frac{{Z}_{o}}{{S}_{i} \times \frac{{S}_{w}}{{S}_{o}}} ,$$
where Sₒ is an output scale factor of the convolution operation, Zᵢ is an input zero point of the convolution operation, Zₒ is an output zero point of the convolution operation, Sᵢ is an input scale factor of the convolution operation, S_{w} is a weight scale factor of the convolution operation, W is a weight of the convolution operation, Z_{w} is a weight zero point of the convolution operation, B is a bias value of the convolution operation, * indicates convolution, and x indicates multiplication, and
$${q}_{1} = \frac{{S}_{i 1} \times {S}_{i 2}}{{S}_{o}} \times {2}^{shift 1} , {q}_{2} = \frac{{S}_{i} \times {S}_{w}}{{S}_{i 1}} \times {2}^{shift 2} ,$$
X₂ is a second input of the element-wise multiplication operation, Sᵢ₁ is a scale factor of a first input of the element-wise multiplication operation, Sᵢ₂ is a scale factor of the second input of the element-wise multiplication operation, Zᵢ₁ is a zero point for the first input of the element-wise multiplication operation, Zᵢ₂ is a zero point for the second input of the element-wise multiplication operation, Sₒ is an output scale factor of the element-wise multiplication operation, Zₒ is an output zero point of the element-wise multiplication operation, Sᵢ is an input scale factor of the convolution operation, and S_{w} is a weight scale factor of the convolution operation, and x indicates multiplication.
